(19) United States
(12) Patent Application Publication
(10) Pub. No.: US 2005/0220488 A1
(43) Pub. Date: Oct. 6, 2005

(54) Image forming apparatus

(75) Inventors: Shigeo Fujita, Nagano-ken (JP); Tatsuro Osawa, Nagano-ken (JP)

Correspondence Address: HOGAN & HARTSON L.L.P., 500 S. GRAND AVENUE, SUITE 1900, LOS ANGELES, CA, 90071-2611, US

(73) Assignee: SEIKO EPSON CORPORATION

(21) Appl. No.: 11/090,957

(22) Filed: Mar. 25, 2005

(30) Foreign Application Priority Data
Mar. 25, 2004 (JP) P2004-089840

(51) Int. Cl. G03G 21/00

(52) U.S. Cl. 399/124

(57) ABSTRACT

An image forming apparatus has a transfer part for transferring a toner image from an intermediate transfer belt whose surface is white to a recording medium. An outer cover for forming a part of a transport path of the recording medium is openable and closeable. A paper-guide cover for covering the intermediate transfer belt and guiding a recording medium passing through the transfer part is provided and is openable and closeable. When the outer cover is opened, the paper-guide cover covers the intermediate transfer belt.

### BACKGROUND OF THE INVENTION

1. Field of the Invention

This invention relates to an image forming apparatus such as a printer, a facsimile, or a copier using electrophotography for forming a toner image on a recording medium of paper, etc., and more particularly to a protection art of a transfer section when a cover is opened and a jam handling art of a recording medium

2. Related Art

Known as an image forming apparatus in a related art is an image forming apparatus wherein for the purpose of preventing a hand or clothes of a human being from touching a transfer roller or a photoconductor drum when a cover body is opened, a transfer roller (21) is built in a case (27) together with a photoconductor drum (13) in one piece, whereby an image formation unit (8) is put into a cartridge so that it can be attached to and detached from an apparatus main unit (2) in one piece and the case (27) is formed with a protective part (27a) for covering the transfer roller (21), thereby preventing a hand from touching the transfer roller (21) and making it possible to almost shield the photoconductor drum (13) from light and a cover body (15) is opened, whereby a paper feed passage is exposed and urging of the transfer roller (21) on the photoconductor drum (13) is released for making it easy to clear a paper jam (Japanese Patent Publication No. JP-A-07-311535).

In the image forming apparatus in the related art described above, the protective part (27a) is fixed to the case (27) and cannot be opened or closed (paragraph 0020 in JP-A-07-311535) and therefore if a paper jam occurs in the transfer section, it is difficult to remove the jammed paper.

### SUMMARY OF THE INVENTION

It is an object of the invention to provide an image forming apparatus capable of protecting a transfer part when a cover is opened and enabling the user to easily remove a recording medium jammed in the transfer part.

According to the invention, there is provided an image forming apparatus having a transfer part of a toner image, characterized in that an outer cover is openable and closeable, that a paper-guide cover for covering the transfer part and guiding a recording medium passing through the transfer part is provided and is openable and closeable, and that when the outer cover is opened, the paper-guide cover covers the transfer part.

According to the configuration, when the outer cover is opened, the paper-guide cover covers the transfer part, so that damage to the transfer part as the user touches the transfer part, etc., carelessly is prevented. That is, when the outer cover is opened, the transfer part is protected.

Since the paper-guide cover is openable and closeable, if a paper jam occurs in the transfer part, the user can easily remove the recording medium by opening the paper-guide cover.

To the end, according to the invention, there is provided an image forming apparatus having a transfer part for transferring a toner image from an intermediate transfer body to a recording medium, characterized in that an outer cover for forming a part of a transport path of the recording medium is openable and closeable, that a paper-guide cover for covering the intermediate transfer body and guiding a recording medium passing through the transfer part is provided and is openable and closeable, and that when the outer cover is opened, the paper-guide cover covers the intermediate transfer body.

According to the configuration, when the outer cover is opened, the paper-guide cover covers the intermediate transfer body, so that damage to the intermediate transfer body as the user touches the intermediate transfer body, etc., carelessly is prevented. That is, when the outer cover is opened, the intermediate transfer body is protected.

Since the paper-guide cover is openable and closeable, if a paper jam occurs in the transfer part, the user can easily remove the recording medium by opening the paper-guide cover.

Particularly, if the surface of the intermediate transfer body is white, for increasing a detection sensitivity of a patch image by a patch sensor, and the intermediate transfer body is exposed when the outer cover is opened, it is highly feared that the user may touch the intermediate transfer body misidentified as paper. However, according to the invention, such a fear is eliminated.

Further, if the intermediate transfer body is shaped like a belt whose surface is white and the white intermediate transfer belt is exposed when the outer cover is opened, it is highly feared that the user may attempt to pull out the intermediate transfer belt misidentified as paper, etc., causing large damage to the intermediate transfer belt. However, according to the invention, such a fear is eliminated.

Preferably, the inside of the outer cover forms a part of the transport path of the recording medium and the transport path is formed so that the recording medium transported over the transport path always exists in the part of the transport path or in the transfer part or in the proximity thereof.

In doing so, if a paper jam occurs in the part of the transport path, the user can remove the paper jammed in the part by opening the outer cover. In this case, the paper-guide cover covers the transfer part and thus the user is prevented from touching the transfer part carelessly or particularly attempting to pull out the white intermediate transfer belt. When the outer cover is opened, if the recording medium is not seen from the user, the recording medium exists in the transfer part or in the proximity thereof. Then, the user can easily remove the recording medium by opening the paper-guide cover. In this case, if the paper-guide cover is open, the recording medium exists therein, so that the user is prevented from touching the transfer part or attempting to pull out the white intermediate transfer belt misidentified as the recording medium.

Preferably, when the paper-guide cover is opened, a roller for forming the transfer part is brought away from the transfer part.

In doing so, it is made possible to more easily remove the recording medium jammed in the transfer part.

Preferably, the paper-guide cover is provided with an urging device for urging the paper-guide cover in a closed direction at all times.

In doing so, opening the paper-guide cover is facilitated and closing the paper-guide cover is not required, so that it is made possible to more easily remove the recording medium jammed in the transfer part.

### BRIEF DESCRIPTION OF THE DRAWINGS

In the accompanying drawings:

FIG. 1 is a sectional side view to show one embodiment of an image forming apparatus according to the invention;

FIG. 2 is a sectional side view with an outer cover opened;

FIG. 3 is a front view with an outer cover opened;

FIG. 4 is a sectional side view further with a paper-guide cover opened; and

FIG. 5 is a front view further with a paper-guide cover opened.

### DETAILED DESCRIPTION OF THE PREFERRED EMBODIMENTS

Referring now to the accompanying drawings, there is shown a preferred embodiment of the invention.

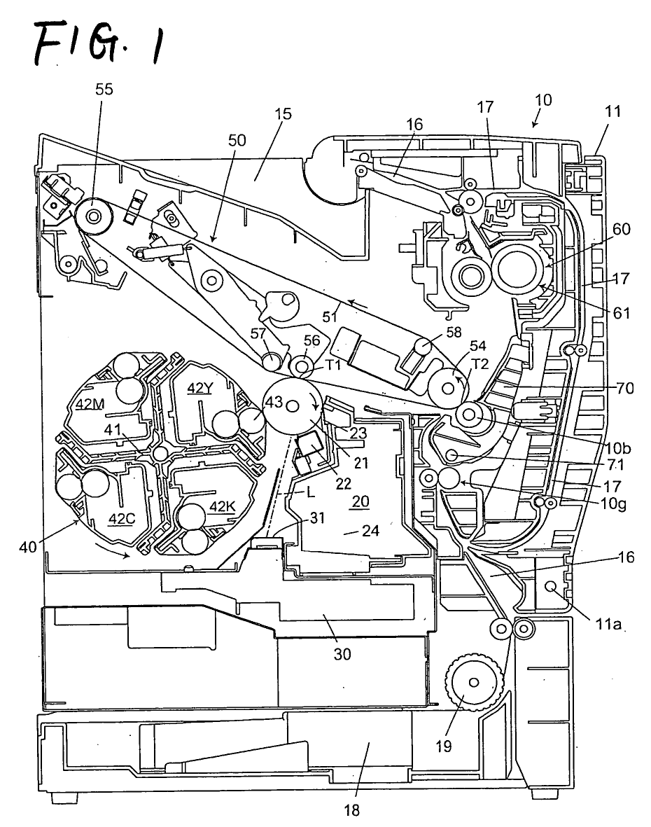

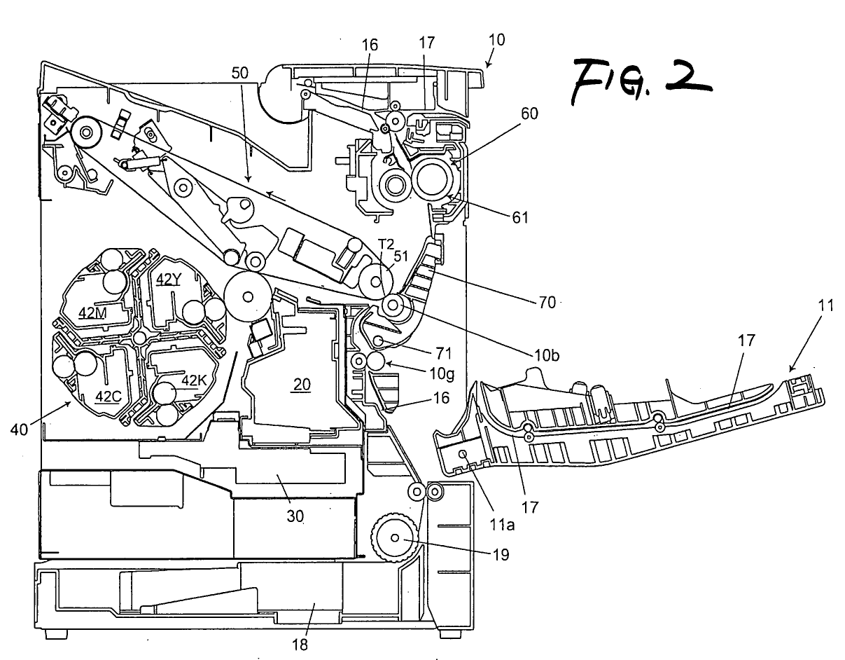

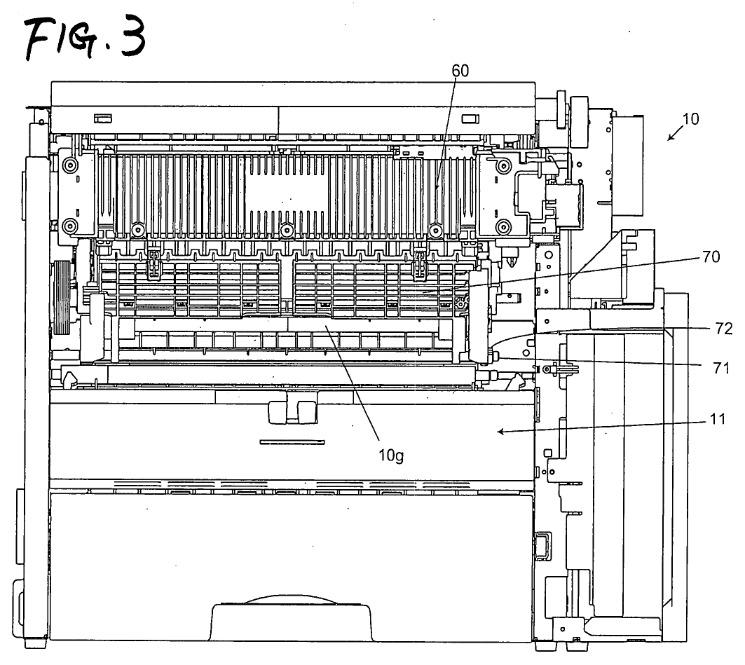

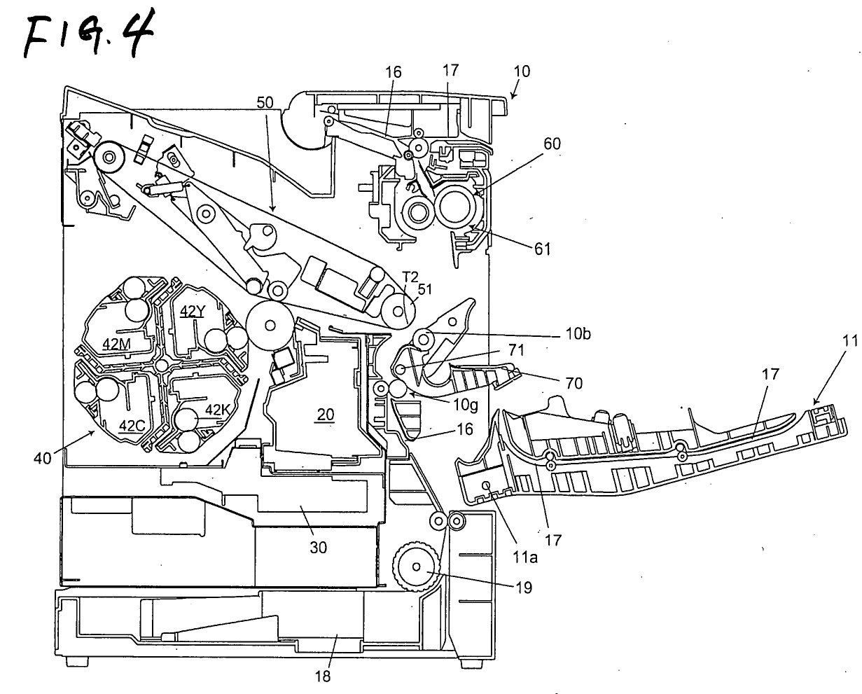

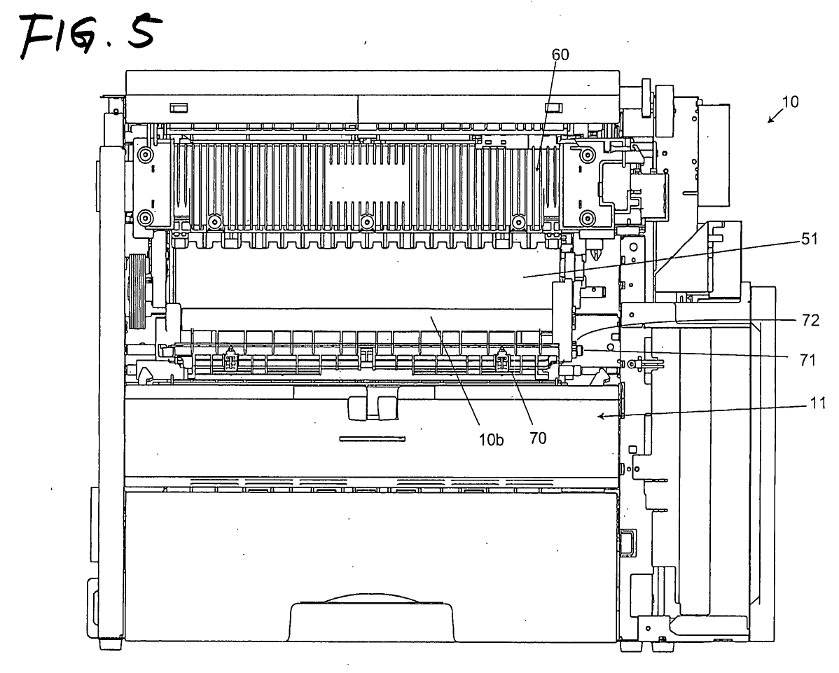

FIG. 1 is a sectional side view to show one embodiment of an image forming apparatus according to the invention, FIG. 2 is a sectional side view with an outer cover opened, FIG. 3 is a front view, FIG. 4 is a sectional side view further with a paper-guide cover opened, and FIG. 5 is a front view.

The image forming apparatus is a color image forming apparatus capable of transporting A3-size or smaller-size paper (recording medium) in a portrait feed state and A4-size or smaller-size paper in a landscape feed state and forming a full-color image on both sides of the paper in a state in which an outer cover 11 is closed as shown in FIG. 1.

The image forming apparatus includes a case 10 and an image support unit 20, an exposure unit 30 as exposure device, a developing machine 40 as developing device, an intermediate transfer body unit 50, and a fixing unit (fixer) 60 as fixing device, which are housed in the case 10.

The case 10 is provided with a frame (not shown) of an apparatus main unit to which the units, etc., are attached.

The image support unit 20 has a photosensitive body 21 having a photosensitive layer on the outer peripheral surface and a corona charger (scorotron charger) 22 as charging device for uniformly charging the outer peripheral surface of the photosensitive body 21. The outer peripheral surface of the photosensitive body 21 uniformly charged by the corona charger 22 is selectively exposed to laser light L from the exposure unit 30 to form an electrostatic latent image, toner of a developer is given to the electrostatic latent image in the developing machine 40 to form a visible image (toner image), and the toner image is primarily transferred to an intermediate transfer belt 51 of an intermediate transfer body of the intermediate transfer body unit 50 in a primary transfer part T1 and further is secondarily transferred to paper in a secondary transfer part T2.

The image support unit 20 is provided with a cleaning device (cleaning blade) 23 for removing the toner remaining on the surface of the photosensitive body 21 after the primary transfer and a waste toner storage section 24 as a waste toner reservoir section for storing the waste toner removed by the cleaning device 23.

The case 10 contains a transport passage 16 for transporting the paper having the toner image formed on one side by the secondary transfer part T2 described above to a paper ejection section (paper ejection tray section) 15 on the top of the case 10 and a return passage 17 for switching back the paper transported to the secondary transfer part T2 on the transport passage 16 and returning the paper to the secondary transfer part T2 to also form an image on an opposite side.

A paper feed tray 18 for stacking and holding a plurality of sheets of paper and a paper feed roller 19 for feeding the paper one sheet at a time to the secondary transfer part T2 are provided in the lower part of the case 10.

The developing machine 40 is a rotary developing machine and has a plurality of developing machine cartridges each storing toner detachably attached to a rotation body main unit 41. In the embodiment, a yellow developing machine cartridge 42Y, a magenta developing machine cartridge 42M, a cyan developing machine cartridge 42C, and a black developing machine cartridge 42K are provided and the rotation body main unit 41 rotates at 90-degree pitches in the arrow direction in FIG. 1, whereby a developing roller 43 can be selectively abutted against the photosensitive body 21 for selectively developing the surface of the photosensitive body 21.

The exposure unit 30 applies the laser light L through an exposure window 31 to the photosensitive body 21.

The intermediate transfer body unit 50 includes a unit frame (not shown), a drive roller 54, a driven roller 55, a primary transfer roller 56, a guide roller 57 for stabilizing the state of the belt 51 in the primary transfer part T1, and a tension roller 58 supports on the unit frame for rotation, and the intermediate transfer belt 51 placed on the rollers and stretched, wherein the belt 51 is circulated in the arrow direction in the figure. The primary transfer part T1 is formed between the photosensitive body 21 and the primary transfer roller 56, and the secondary transfer part T2 is formed in the press contact part of the drive roller 54 and a secondary transfer roller 10b provided in the main unit.

The secondary transfer roller 10b can be brought into and out of contact with the drive roller 54 (therefore the intermediate transfer belt 51). When the secondary transfer roller 10b comes in contact with the drive roller 54, the secondary transfer part T2 is formed.

Therefore, to form a color image, toner images of a plurality of colors are superposed on each other with the secondary transfer roller 10b out of contact with the intermediate transfer belt 51 to form a color image and then the secondary transfer roller 10b comes in contact with the intermediate transfer belt 51 and paper is supplied to the contact part (secondary transfer part T2) at the timing controlled in a gate roller pair 10g, whereby the color image (toner image) is transferred to the paper.

The paper to which the toner image has been transferred passes through a heating roller pair 61 of the fixing unit 60, whereby the toner image is fused and fixed and the paper is ejected to the paper ejection section 15.

The intermediate transfer belt 51 is a belt whose surface is white.

The outer cover (front cover) 11 is openable and closeable with a shaft 11a as the center, as shown in FIGS. 1 and 2.

The transport path of a recording medium is made up of the transport passage 16 and the return passage 17 and the inner face of the outer cover 11 forms a part of the return passage 17 and therefore a part of the transport path of a recording medium as apparent from FIGS. 1 and 2.

The transport path of a recording medium (transport passage 16 and return passage 17) is formed so that the recording medium transported over the transport path always exists in the part of the transport path or in the secondary transfer part T2 or in the proximity thereof.

More particularly, the gate roller pair 10g, the secondary transfer part T2, and the heating roller pair 61 of the fixing unit 60 making up a recording medium transport section are placed in the transport path so that when a paper jam occurs in the transport path of a recording medium, if the recording medium is an A3-size recording medium, the recording medium exists in the transport passage 16 or exists across the transport passage 16 and the return passage 17 and if the recording medium is a recording medium whose feed direction length is shorter than the landscape length of the A4 size, the recording medium exists across the transport passage 16 and the return passage 17 or exists in the transport passage 16 or exists in the secondary transfer part T2 or in the proximity thereof or in the return passage 17.

In FIGS. 1 and 2, numeral 70 denotes a paper-guide cover for covering the secondary transfer part T2 and the intermediate transfer belt 51 and guiding the recording medium passing through the secondary transfer part T2.

The paper-guide cover 70 is openable and closeable with a shaft 71 as the center, but a torsion spring 72 as urging device (see FIG. 3) is provided between the paper-guide cover 70 and the image forming apparatus main unit for urging the paper-guide cover 70 in the closed direction (the direction in the state in FIGS. 1 and 2 and counterclockwise in the figures) at all times.

Therefore, if the outer cover 11 is opened as shown in FIGS. 2 and 3, the paper-guide cover 70 is closed as shown in FIGS. 2 and 3 for covering the secondary transfer part T2 and the intermediate transfer belt 51, but can be opened against the urging force of the urging device 72 as shown in FIGS. 4 and 5.

When the outer cover 11 is closed as shown in FIG. 1, the secondary transfer roller 10b is urged against the intermediate transfer belt 51 by an urging device (not shown) and the secondary transfer part T2 can be formed as described above. If the outer cover 11 is opened as shown in FIG. 2, urging the secondary transfer roller 10b by the urging device is released by the action of an urging release device not shown (for example, a link) and further if the paper-guide cover 70 is opened as shown in FIG. 4, the secondary transfer roller 10b is brought away from the intermediate transfer belt 51 (therefore, the secondary transfer part T2) as shown in the figure.

According to the image forming apparatus as described above, the following advantages can be provided:

(a) The image forming apparatus has the transfer part T2 of a toner image, wherein the outer cover 11 is openable and closeable, wherein the paper-guide cover 70 for covering the transfer part T2 and guiding a recording medium passing through the transfer part T2 is provided and is openable and closeable, and wherein when the outer cover is opened, the paper-guide cover 70 covers the transfer part T2. Thus, according to the image forming apparatus, the following advantages can be provided:

When the outer cover 11 is opened as shown in FIGS. 2 and 3, the paper-guide cover 70 covers the transfer part T2, so that damage to the transfer part T2 as the user touches the transfer part T2, etc., carelessly is prevented. That is, when the outer cover is opened, the transfer part T2 is protected.

Since the paper-guide cover 70 is openable and closeable, if a paper jam occurs in the transfer part T2, the user can easily remove the recording medium by opening the paper-guide cover 70 as shown in FIGS. 4 and 5.

(b) The image forming apparatus has the transfer part T2 for transferring a toner image from the intermediate transfer body 51 to a recording medium, wherein the outer cover 11 for forming a part of the transport path 16, 17 of the recording medium is openable and closeable, wherein the paper-guide cover 70 for covering the intermediate transfer body 51 and guiding a recording medium passing through the transfer part T2 is provided and is openable and closeable, and wherein when the outer cover 11 is opened, the paper-guide cover 70 covers the intermediate transfer body 51. Thus, according to the image forming apparatus, the following advantages can be provided:

When the outer cover 11 is opened as shown in FIGS. 2 and 3, the paper-guide cover 70 covers the intermediate transfer body 51, so that damage to the intermediate transfer body 51 as the user touches the intermediate transfer body 51, etc., carelessly is prevented. That is, when the outer cover is opened, the intermediate transfer body 51 is protected. If the user touches the surface of the intermediate transfer body, a fingerprint or grease is deposited on the surface of the intermediate transfer body and a defect occurs on the later formed image, but such an accident is prevented.

Since the paper-guide cover 70 is openable and closeable, if a paper jam occurs in the transfer part T2, the user can easily remove the recording medium by opening the paper-guide cover 70.

Particularly, assuming that the intermediate transfer body 51 is exposed when the outer cover 11 is opened as shown in FIGS. 2 and 3 if the surface of the intermediate transfer body 51 is white as in the embodiment, it is highly feared that the user may touch the intermediate transfer body 51 misidentified as paper. However, according to the embodiment, such a fear is eliminated.

Further, assuming that the white intermediate transfer body 51 is exposed when the outer cover 11 is opened as shown in FIGS. 2 and 3 if the intermediate transfer body 51 is shaped like a belt whose surface is white as in the embodiment, it is highly feared that the user may attempt to pull out the intermediate transfer belt misidentified as paper, etc., causing large damage to the intermediate transfer belt 51. However, according to the embodiment, such a fear is eliminated.

(c) The inside of the outer cover 11 forms a part of the transport path 16, 17 of the recording medium (part and most of the return passage 17) and the transport path is formed so that when the recording medium transported over the transport path 16, 17 is jammed, it always exists in the part of the transport path 16, 17 or in the transfer part T2 or in the proximity thereof. Thus, if a paper jam occurs in the part of the transport path, the user can remove the paper jammed in the part by opening the outer cover 11 as shown in FIGS. 2 and 3. In this case, the paper-guide cover 70 covers the transfer part T2 and thus the user is prevented from touching the transfer part carelessly or particularly attempting to pull out the white intermediate transfer belt 51. When the outer cover 11 is opened, if the recording medium is not seen from the user, the recording medium exists in the transfer part T2 or in the proximity thereof. Then, the user can easily remove the recording medium by opening the paper-guide cover 70 as shown in FIGS. 4 and 5. In this case, if the paper-guide cover 70 is open, the recording medium exists therein (recording medium is not shown in FIG. 4 or 5), so that the user is prevented from touching the transfer part or attempting to pull out the white intermediate transfer belt 51 misidentified as the recording medium.

(d) When the paper-guide cover 70 is opened as shown in FIGS. 4 and 5, the roller 10b forming the transfer part T2 is brought away from the transfer part T2. Thus, it is made possible to more easily remove the recording medium jammed in the transfer part T2.

(e) The paper-guide cover 70 is provided with the urging device 72 for urging the paper-guide cover 70 in the closed direction at all times. Thus, unlocking operation, etc., is not required, opening the paper-guide cover is facilitated and closing the paper-guide cover 70 is not required, so that it is made possible to more easily remove the recording medium jammed in the transfer part T2.

Although the embodiment of the invention has been described, it is to be understood that the invention is not limited to the specific embodiment thereof and various modifications and changes may be made without departing from the spirit and the scope of the invention.

For example, the following configuration may be adopted: The paper-guide cover 70 is provided with a lock mechanism of a solenoid, etc., and a paper jam position is detected with a plurality of paper detectors provided at proper positions of the recording medium transfer path 16, 17. When a paper jam occurs in the return passage 17, if the outer cover 11 is opened, the lock mechanism locks the paper-guide cover 70 in the closed state. When a paper jam occurs in the secondary transfer part T2 or in the proximity thereof, the paper-guide cover 70 locked by the lock mechanism is unlocked in association with the open state of the outer cover 11 and the paper-guide cover 70 is automatically opened under its own weight or by an urging device (urging device in the open direction).

1. An image forming apparatus having a transfer part of a toner image, comprising:
an outer cover openable and closeable, a paper-guide cover openable and closeable, and for covering the transfer part and guiding a recording medium passing through the transfer part, wherein when the outer cover is opened, the paper-guide cover covers the transfer part.

2. An image forming apparatus having a transfer part for transferring a toner image from an intermediate transfer body to a recording medium, comprising:
an outer cover openable and closeable, and for forming a part of a transport path of the recording medium;
a paper-guide cover openable and closeable, and for covering the intermediate transfer body and guiding a recording medium passing through the transfer part,
wherein when the outer cover is opened, the paper-guide cover covers the intermediate transfer body.

3. The image forming apparatus according to claim 2 wherein a surface of the intermediate transfer body is white.

4. The image forming apparatus according to claim 2 wherein the intermediate transfer body is shaped like a belt and a surface thereof is white.

5. The image forming apparatus according to claim 1, wherein an inside of the outer cover forms a part of the transport path of the recording medium and the transport path is formed so that the recording medium transported over the transport path always exists in the part of the transport path or in the transfer part or in the proximity thereof.

6. The image forming apparatus according to claim 1, wherein when the paper-guide cover is opened, a roller for forming the transfer part is brought away from the transfer part.

7. The image forming apparatus according to claim 1, wherein the paper-guide cover is provided with an urging device for always urging the paper-guide cover in a closed direction.
